(19) United States
(12) Patent Application Publication
(10) Pub. No.: US 2026/0070146 A1
(43) Pub. Date: Mar. 12, 2026

(54) RESISTANCE SPOT WELDING METHOD

(71) Applicant: TOYOTA JIDOSHA KABUSHIKI KAISHA, Toyota-shi, Aichi-ken (JP)

(72) Inventors: Shuhei OGURA, Nagakute-shi (JP); Tomohiko SEKIGUCHI, Nagakute-shi (JP); Kyosuke IZUNO, Nisshin-shi (JP); Yosuke TAMADA, Toyota-shi (JP); Takahiro FUKAYA, Okazaki-shi (JP)

(73) Assignee: TOYOTA JIDOSHA KABUSHIKI KAISHA, Toyota-shi, Aichi-ken (JP)

(21) Appl. No.: 19/108,332

(22) PCT Filed: Apr. 20, 2023
(86) PCT No.: PCT/JP2023/015769

§ 371 Date: Mar. 3, 2025

(30) Foreign Application Priority Data
Sep. 16, 2022 (JP) 2022-147720

(51) Int. Cl. B23K 11/11; B23K 11/16; B23K 11/24

(52) U.S. Cl. CPC B23K 11/115; B23K 11/163; B23K 11/24

(57) ABSTRACT

A resistance spot welding method includes a pre-energization step of performing energization on metal plates as a welding target until an alloy layer diameter reaches a predetermined target diameter, the alloy layer being formed at an outer periphery of a nugget in a welded part of the metal plates and including a constituent material of a plating layer of the metal plate and a base metal of the metal plate; and a main energization step of performing energization after the pre-energization step. The pre-energization step includes a pulsation energization that repeatedly alternates a high current energization and a low current energization, the high current energization being performed at a current higher than a predetermined threshold current, the low current energization being performed at a current lower than or equal to the threshold current. The pulsation energization includes performing the high current energization two times or more.

### CROSS REFERENCE TO RELATED APPLICATIONS

The present application claims priority to Japanese Patent Application No. 2022-147720 filed on Sep. 16, 2022, the disclosure of which is incorporated herein by reference in its entirety.

### FIELD

The present disclosure relates to a resistance spot welding method.

### RELATED ART

For resistance spot welding, there is a known technique in which energization is performed by dividing into a main energization and a pre-energization, performed prior to the main energization.

WO2015/083381 describes a technique in which a pre-energization (initial energization) is performed over a plurality of stages of a high current energization and a low current energization, the high current energization being performed at a high current, the low current energization being performed at a low current.

When the high current energization is performed for a long time, there is a concern that a nugget may grow rapidly, thus generating spatter. However, when only the low current energization is performed, there is a concern that growing a nugget to a desired size requires too much time. Therefore, there has been a demand for a technique that can grow a nugget to a desired size within a short time while suppressing generation of spatter.

### SUMMARY

The present disclosure has been made to solve the above-described problems, and can be achieved by the following aspects.

(1) According to one aspect of the present disclosure, a resistance spot welding method is provided. This resistance spot welding method includes: a pre-energization step of performing energization on metal plates as a welding target until an alloy layer diameter reaches a predetermined target diameter, wherein the alloy diameter is a diameter of an alloy layer, the alloy layer is formed at an outer periphery of a nugget in a welded part of the metal plates, the alloy layer includes a constituent material of a plating layer of the metal plate and a base metal of the metal plate; and a main energization step of performing energization after the pre-energization step. The pre-energization step includes a pulsation energization that repeatedly alternates a high current energization and a low current energization at intervals of less than 10 ms, the high current energization being performed at a current higher than a predetermined threshold current, the low current energization being performed at a current lower than or equal to the threshold current. The pulsation energization includes performing the high current energization two times or more.

According to the resistance spot welding method of the present aspect, the high current energization and the low current energization are repeatedly alternated at short time intervals of less than 10 ms in the pre-energization step and hence, a nugget having a desired size may be created within a short time while suppressing generation of spatter.

(2) In the resistance spot welding method of the above-mentioned aspect, the main energization step may include a slope energization that performs energization while increasing a current over time, and a constant current energization that performs energization at a constant current.

According to the resistance spot welding of the present aspect, compared with the case in which only the slope energization or only the constant current energization is performed, a nugget may be grown within a short time while suppressing a sharp rise in temperature in a fusion zone of a workpiece.

(3) In the resistance spot welding method of the above-mentioned aspect, the main energization step may include performing the energization until a nugget diameter, which is a diameter of the nugget, reaches a pre-determined target nugget diameter, and the target diameter may be 1.2 times or more the target nugget diameter.

According to the resistance spot welding of the present aspect, generation of spatter may be suppressed.

(4) In the resistance spot welding method of the above-mentioned aspect, the current in the low current energization may be ⅓ times or more and ⅔ times or less the current in the high current energization.

According to the resistance spot welding of the present aspect, the situation in which a current cannot rise completely up to a high current after performing energization at a low current may be suppressed, and the situation in which an alloy layer is not formed may be suppressed.

(5) In the resistance spot welding method of the above-mentioned aspect, the main energization step may include a constant current energization that performs energization at a constant current that is lower than or equal to the current in the high current energization and is higher than or equal to the current in the low current energization.

According to the resistance spot welding of the present aspect, a nugget having a desired size may be created within a short time while suppressing generation of spatter.

(6) In the resistance spot welding method of the above-mentioned aspect, the main energization step may include performing the slope energization while increasing the current up to a predetermined first current and then performing the constant current energization at a current higher than or equal to the first current.

According to the resistance spot welding of the present aspect, a nugget having a desired size may be created within a short time while suppressing generation of spatter.

The present disclosure can be achieved by various aspects, and can be achieved by a resistance spot welding device, for example.

### BRIEF DESCRIPTION OF THE DRAWINGS

The above-mentioned objects, other objects, features, and advantages of the present disclosure will become more apparent from the following detailed description with reference to attached drawings.

FIG. 1 is a diagram showing the configuration of a resistance spot welding device;

### FIG. 2 is a flowchart showing an example of resistance spot welding;

FIG. 3 is a diagram showing the results of experiments performed to check the relationship between the ratio of alloy layer diameter to nugget diameter and generation or non-generation of spatter;

FIG. 4 is a graph showing an example of changes in current;

FIG. 5 is a graph showing an example of changes in current in a second embodiment; and

FIG. 6 is a graph showing an example of changes in current in a third embodiment.

### DETAILED DESCRIPTION

### A. First Embodiment

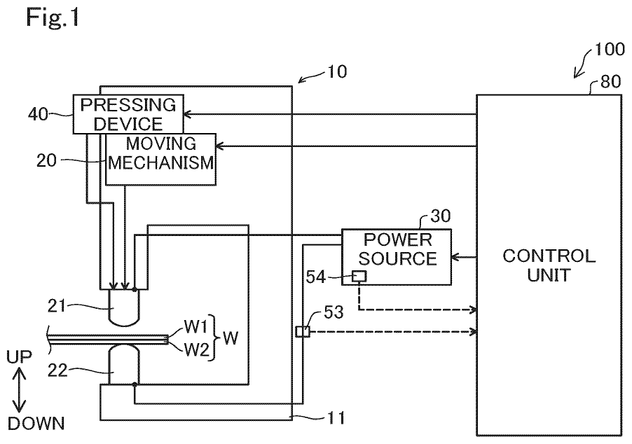

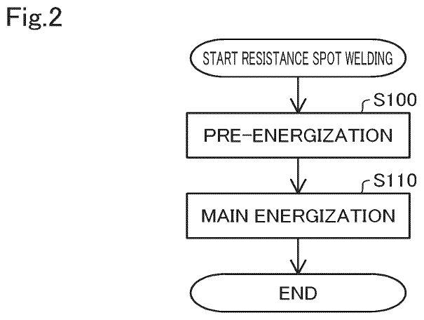

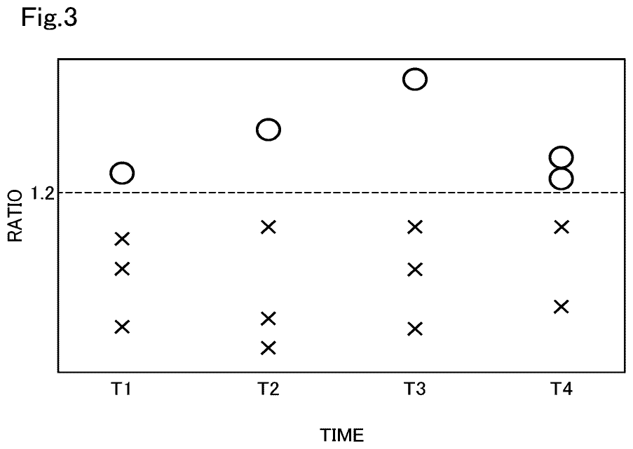

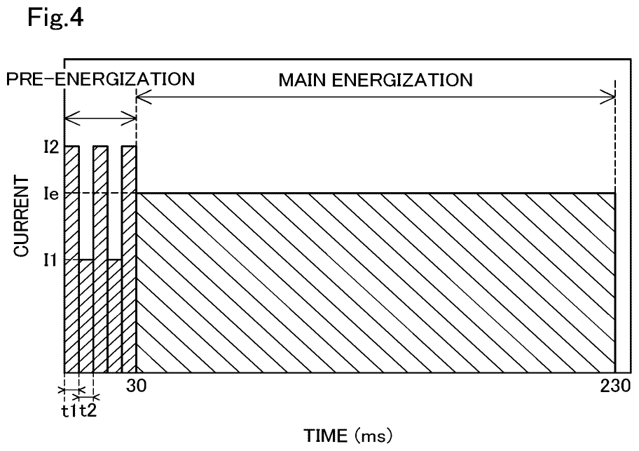

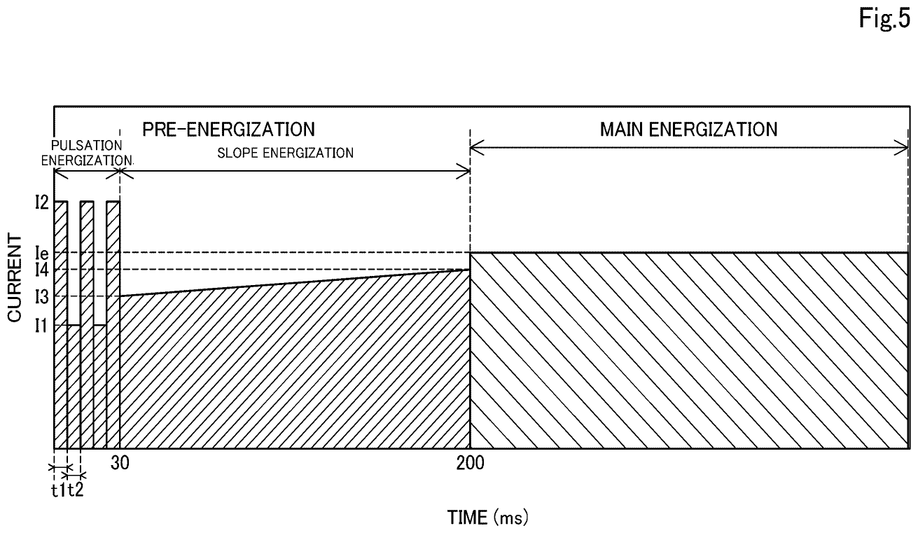

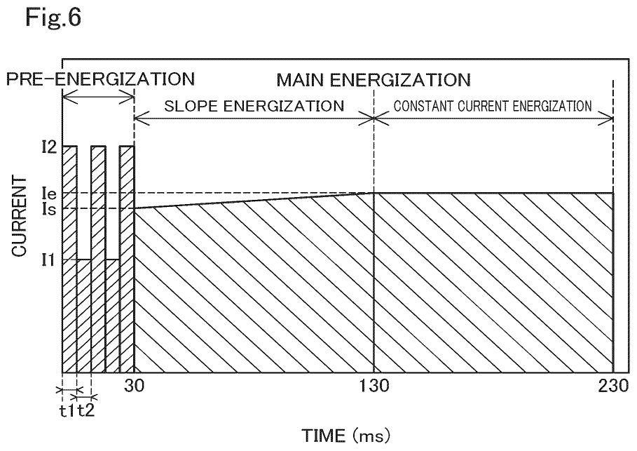

FIG. 1 is a schematic view showing the configuration of a resistance spot welding device 100 of the present embodiment. In the description made hereinafter, as shown in FIG. 1, the up-down direction is a direction parallel to an ascending/descending direction along which an upper electrode tip 21 described later ascends/descends, the upper electrode tip 21 being a movable electrode. The resistance spot welding device 100 joins two or more metal plates by resistance spot welding, the two or more metal plates being made to overlap with each other to form a member to be joined W. The resistance spot welding device 100 includes a welding gun 10, a power source 30, a current sensor 53, a voltage sensor 54, and a control unit 80.

The member to be joined W is a steel plate. An example of the member to be joined W may be a steel plate having, on the surface thereof, a plating layer formed of a galvanized layer, a galvannealed layer, a zinc oxide film, or an aluminum/silicon alloy. The present embodiment shows, as an example, a case in which a first metal plate W1 and a second metal plate W2, which are two or more metal plates, are made to overlap with each other as the member to be joined W.

The welding gun 10 is attached to the distal end of a robot arm not shown in the drawing. A gun body 11 is moved to a target welding point of the member to be joined W by the robot arm. The welding gun 10 includes the gun body 11, a moving mechanism 20, a pair of electrode tips 21, 22 facing each other, and a pressing device 40. The upper electrode tip 21 is a movable electrode, and is attached to the upper part of the gun body 11. The lower electrode tip 22 is a fixed electrode, and is attached to the lower part of the gun body 11 at a position that faces the upper electrode tip 21. A configuration may be adopted in which the upper electrode tip 21 is a fixed electrode, and the lower electrode tip 22 is a movable electrode.

The moving mechanism 20 causes the upper electrode tip 21 to ascend and descend. The moving mechanism 20 includes a servo motor not shown in the drawing. The moving mechanism 20 converts the rotational force of the servo motor into a linear moving force in the ascending/descending direction, and transfers the converted linear moving force to the upper electrode tip 21 to cause the upper electrode tip 21 to ascend and descend. The power source 30 supplies a target current value of a welding current between the pair of electrode tips 21, 22. The pressing device 40 includes a cylinder not shown in the drawing, and presses the member to be joined W by pushing the electrode tips 21, 22 against the member to be joined W.

The current sensor 53 detects the current value of the welding current supplied from the power source 30, and transmits a signal showing the current value to the control unit 80 at predetermined time intervals. The current sensor 53 is achieved by using a toroidal coil, for example. The voltage sensor 54 detects a voltage value between the upper electrode tip 21 and the lower electrode tip 22 at predetermined time intervals, and transmits a signal showing the voltage value to the control unit 80.

The control unit 80 is a microcomputer or the like constituted of a central processing unit (CPU), a RAM, and a ROM. When the microcomputer executes a program installed in advance, the control unit 80 controls the operation of the resistance spot welding device 100. More specifically, the control unit 80 integrally controls the current value, the energization time, the pressing force from the electrodes, the energization timing, the pressing timing, and the like. However, some or all of these functions may be achieved by a hardware circuit.

FIG. 2 is a flowchart showing an example of resistance spot welding. In step S100, the resistance spot welding device 100 performs welding by a pre-energization. This step is also referred to as a pre-energization step. In the present embodiment, the pre-energization refers to energization that is performed until an alloy layer diameter reaches a predetermined target diameter, the alloy layer diameter being the diameter of an alloy layer formed in the member to be joined W. More specifically, the pre-energization is energization performed for a time and at a current that allow the alloy layer diameter to reach the target diameter, the time and the current being experimentally and empirically obtained in advance.

The alloy layer is a layer in which the first metal plate W1 and the second metal plate W2 are fused, thus forming an alloy. More specifically, the alloy layer is a layer formed at the outer periphery of a nugget in a welded part, and including constituent materials of the plating layers of the first metal plate W1 and the second metal plate W2 as the welding target, and base metals of the first metal plate W1 and the second metal plate W2. The alloy layer diameter can be obtained by, for example, performing a measurement at a position determined to be within the alloy layer as the result of observations using a scanning electron microscope (SEM).

As the temperature at the boundary part between the first metal plate W1 and the second metal plate W2 rises due to energization, an alloy layer is formed. For example, an alloy layer is formed when the temperature of the member to be joined W is 1200 degrees or more and 1500 degrees or less. When energization is continued, the alloy layer grows, thus increasing an alloy layer diameter. When the energization is further continued, a nugget is formed at the center part of the alloy layer as the temperature rises in a fusion zone at which the first metal plate W1 and the second metal plate W2 are fused.

In the present embodiment, the target diameter is 1.2 times the target nugget diameter, which is the desired diameter of the nugget formed in a main energization step described later. It is preferable that the target diameter be 1.2 times or more and 1.5 times or less the target nugget diameter. The nugget diameter can be estimated by using, for example, the amount of expansion of the member to be joined W in the direction of the perpendicular line with respect to the surface direction of the member to be joined W, and by using the value of electric resistance between the pair of the electrode tip 21 and the electrode tip 22.

FIG. 3 is a diagram showing the results of experiments performed to check the relationship between the ratio of alloy layer diameter to nugget diameter and generation or non-generation of spatter. In FIG. 3, cross marks indicate generation of spatter, and circle marks indicate non-generation of spatter. As shown in FIG. 3, when the ratio of alloy layer diameter to nugget diameter is lower than 1.2, spatter is frequently generated irrespective of the length of time of performing energization. When the ratio of alloy layer diameter to nugget diameter is more than 1.2, generation of spatter is suppressed irrespective of the length of time of performing energization. That is, it is experimentally confirmed that when the alloy layer diameter is 1.2 times or more the target nugget diameter, generation of spatter is suppressed compared with the case in which the alloy layer diameter is less than 1.2 times the target nugget diameter.

In the present embodiment, in the pre-energization step, a pulsation energization is performed in which a high current energization and a low current energization are repeatedly alternated at intervals of less than 10 ms, the high current energization being performed at a current higher than a predetermined threshold current, the low current energization being performed at a current lower than or equal to the threshold current.

The threshold current can be experimentally or empirically determined in advance.

In step S110 (see FIG. 2), the resistance spot welding device 100 performs welding by a main energization. This step is also referred to as the main energization step. In the present embodiment, the main energization step is a step in which energization is performed until the nugget diameter reaches the predetermined target nugget diameter. In the present embodiment, in the main energization step, a constant current energization is performed in which energization is performed at a constant current. A current in the constant current energization may be experimentally or empirically determined in advance.

FIG. 4 is a graph showing an example of changes in current in resistance spot welding. In FIG. 4, current is shown as the vertical axis, and time is shown as the horizontal axis. In the present embodiment, the resistance spot welding device 100 performs the pre-energization step for 30 ms and, thereafter, performs the main energization step for 200 ms.

In the present embodiment, the pulsation energization includes performing the high current energization three times and performing the low current energization two times. More specifically, the high current energization is performed for 6 ms and, thereafter, the low current energization is performed for 6 ms, and the high current energization is performed for 6 ms again and, thereafter, the low current energization is performed for 6 ms again, and the high current energization is performed last for 6 ms. All of the high current energizations are performed at the same high current I1, and all of the low current energizations are performed at the same low current I2.

It is preferable that the high current I1 be higher than or equal to 8 kA, and lower than or equal to 15 KA. It is preferable that an energization time t1 at the high current I1 be 4 ms or more and 8 ms or less. It is preferable that the low current I2 be higher than or equal to ⅓ of the high current I1, and lower than or equal to ⅔ of the high current I1. When the difference between the high current I1 and the low current I2 is excessively large, there is a concern that a current cannot rise completely up to the high current I1 after performing energization at the low current I2, so that welding cannot be performed. In contrast, when the difference between the high current I1 and the low current I2 is excessively small, there is a concern that an alloy layer is not formed by energization at the low current I2, and a nugget is formed. Therefore, it is preferable that the difference between the high current I1 and the low current I2 be approximately 5kA. It is preferable that an energization time t2 at the low current I2 be 4 ms or more and 8 ms or less. It is preferable that the pulsation energization include performing the high current energization two times or more and five times or less. It is preferable that a total energization time t3 in the pulsation energization be 20 ms or more and 40 ms or less.

In the present embodiment, for the main energization, the constant current energization is performed in which energization is performed at a constant current Ie for 200 ms. It is preferable that the current Ie be lower than or equal to the high current I1, and higher than or equal to the low current I2.

According to the resistance spot welding method of the present embodiment described above, in the pre-energization step, the high current energization and the low current energization are repeatedly alternated at short time intervals of less than 10 ms and hence, the high current energizations can raise the temperature at the welding point of the member to be joined W to a temperature range in which an alloy layer is formed, whereas the low current energizations can suppress generation of spatter. That is, it is possible to create a nugget having a desired size within a short time while suppressing generation of spatter.

The high current energization is performed last in the pre-energization step and, thereafter, the process advances to the main energization step. Therefore, it is possible to avoid a rapid increase in current when the process advances from the pre-energization step to the main energization step. As a result, it is possible to suppress a sharp rise in temperature in a fusion zone of the member to be joined W in the main energization step and hence, generation of spatter can be suppressed.

In addition, the diameter of an alloy layer formed in the pre-energization is 1.2 times or more the desired diameter of a nugget formed in the main energization. Therefore, generation of spatter can be suppressed compared with the case in which an alloy layer diameter is less than 1.2 times the desired nugget diameter.

The low current I2 is ⅓ times or more and ⅔ times or less the high current I1. Therefore, it is possible to suppress the situation in which a current cannot rise completely up to the high current I1 after performing energization at the low current I2, and it is also possible to suppress the situation in which an alloy layer is not formed.

The current Ie in the main energization step is lower than or equal to the high current I1, and is higher than or equal to the low current I2. Therefore, it is possible to create a nugget having a desired size within a short time while suppressing generation of spatter.

### B. Second Embodiment

A spot welding method of a second embodiment differs from the spot welding method of the first embodiment in that a pre-energization step (see step S100 in FIG. 2) includes a slope energization in which energization is performed while increasing a current over time, but other steps of the spot welding method of the second embodiment are equal to the corresponding steps in the first embodiment. The configuration of a resistance spot welding device 100 of the second embodiment is equal to the configuration of the resistance spot welding device 100 of the first embodiment and hence, the description of the configuration of the resistance spot welding device 100 will be omitted.

FIG. 5 is a graph showing an example of changes in current in the second embodiment. In FIG. 5, current is shown as the vertical axis, and time is shown as the horizontal axis. In the present embodiment, the resistance spot welding device 100 performs the pre-energization step for 200 ms and, thereafter, performs the main energization step for 200 ms.

In the slope energization in the second embodiment, energization is performed while increasing a current over time from a current I3 up to a current I4, the current I3 being higher than or equal to the low current I2 and lower than or equal to the high current I1, the current I4 being higher than the current I3 and lower than or equal to the high current I1.

According to the resistance spot welding method of the second embodiment described above, the pulsation energization is performed, and the slope energization is then performed and hence, it is possible to create a larger alloy layer while maintaining the ratio between nugget diameter and alloy layer diameter.

### C: Third Embodiment

A spot welding method of a third embodiment differs from the spot welding method of the first embodiment in that a main energization step (see step S110 in FIG. 2) includes a slope energization, but other steps of the spot welding method of the third embodiment are equal to the corresponding steps in the first embodiment. The configuration of a resistance spot welding device 100 of the third embodiment is equal to the configuration of the resistance spot welding device 100 of the first embodiment and hence, the description of the configuration of the resistance spot welding device 100 will be omitted.

FIG. 6 is a graph showing an example of changes in current in the third embodiment. In FIG. 6, current is shown as the vertical axis, and time is shown as the horizontal axis. In the present embodiment, the resistance spot welding device 100 performs the pre-energization step for 30 ms and, thereafter, performs the main energization step for 200 ms.

In a main energization in the third embodiment, the slope energization is performed for 100 ms and, thereafter, the constant current energization is performed for 100 ms at the current Ie. In the slope energization, energization is performed while increasing a current up to the current Ie from a current Is, which is higher than or equal to the low current I2 and lower than or equal to the current Ie. It is preferable that, for the slope energization, energization be performed that increases a current up to a current lower than or equal to a current in the constant current energization. That is, it is preferable that the current in the constant current energization be higher than or equal to the current that is increased in the slope energization.

According to the resistance spot welding method of the third embodiment described above, compared with the case in which only the slope energization or only the constant current energization is performed for the main energization, it is possible to grow a nugget within a short time while suppressing a sharp rise in temperature in a fusion zone of a workpiece.

In the slope energization, energization is performed by increasing a current up to a predetermined first current, that is, up to the current Ie, and the constant current energization is then performed at the current Ie. Therefore, it is possible to create a nugget having a desired size within a short time while suppressing generation of spatter.

### D. Other Embodiments

(D1) In the above-described embodiment, the pulsation energization includes performing the high current energization three times and performing the low current energization two times. However, the configuration is not limited to such a configuration, and it is sufficient that the pulsation energization include performing the high current energization two times or more. More specifically, it is sufficient that the pulsation energization include energization in which a first high current energization, a first low current energization, and a second high current energization are performed in this order, the first high current energization being performed at a first high current for less than 10 ms, the first low current energization being performed at a low current lower than the first high current for less than 10 ms, the second high current energization being performed at a second high current higher than the low current for less than 10 ms.

(D2) In the above-described embodiment, the pulsation energization starts from the high current energization. However, the configuration is not limited to such a configuration, and the pulsation energization may start from the low current energization.

(D3) In the above-described embodiment, all of the high current energizations are performed at the same high current I1 for the same energization time t1, and all of the low current energizations are performed at the same low current I2 for the same energization time t2. However, the configuration is not limited to such a configuration and, in the pulsation energization, the current and the energization time for each high current energization, and the current and the energization time for each low current energization may be suitably determined provided that the high current energization is always performed at a current higher than the current in the low current energization.

(D4) In the above-described second embodiment, the pre-energization step includes performing the pulsation energization and then performing the slope energization. However, the configuration is not limited to such a configuration, and the pre-energization step may include performing the slope energization and then performing the pulsation energization. Alternatively, the pre-energization step may include performing the pulsation energization and the slope energization a plurality of times.

(D5) In the above-described third embodiment, the main energization step includes performing the slope energization and then performing the constant current energization. However, the configuration is not limited to such a configuration, and the main energization step may include performing the constant current energization and then performing the slope energization, or may include performing only the slope energization. Alternatively, the main energization step may include performing the constant current energization and the slope energization a plurality of times.

(D4) Energization obtained by combining the above-described second embodiment and the above-described third embodiment may be performed. More specifically, the pre-energization step may include performing the pulsation energization and then performing the slope energization, and the main energization step may include performing the slope energization and then performing the constant current energization.

The present disclosure is not limited to the above-described embodiments, and may be achieved by various configurations without departing from the gist of the present disclosure. For example, to solve the above-described problem or to achieve a part or the whole of the above-described effects, technical features in the embodiments that correspond to technical features in respective aspects described in SUMMARY may be suitably replaced or combined with each other.

Further, if such a technical feature is not described in this specification as an essential technical feature, the technical feature may be deleted as appropriate.

### Reference Signs List

10 Welding gun
11 Gun body
20 Moving mechanism
21 Upper electrode tip
22 Lower electrode tip
30 Power source
40 Pressing device
53 Current sensor
54 Voltage sensor
80 Control unit
100 resistance spot welding device
W Member to be joined
W1 First metal plate
W2 Second metal plate

1. A resistance spot welding method comprising:
a pre-energization step of performing energization on metal plates as a welding target until an alloy layer diameter reaches a predetermined target diameter, wherein the alloy diameter is a diameter of an alloy layer, the alloy layer is formed at an outer periphery of a nugget in a welded part of the metal plates, the alloy layer includes a constituent material of a plating layer of the metal plate and a base metal of the metal plate; and
a main energization step of performing energization after the pre-energization step, wherein
the pre-energization step includes a pulsation energization that repeatedly alternates a high current energization and a low current energization at intervals of less than 10 ms, the high current energization being performed at a current higher than a predetermined threshold current, the low current energization being performed at a current lower than or equal to the threshold current, and
the pulsation energization includes performing the high current energization two times or more.

2. The resistance spot welding method according to claim 1, wherein the main energization step includes a slope energization that performs energization while increasing a current over time, and a constant current energization that performs energization at a constant current.

3. The resistance spot welding method according to claim 1, wherein the main energization step includes performing the energization until a nugget diameter, which is a diameter of the nugget, reaches a pre-determined target nugget diameter, and
the target diameter is 1.2 times or more the target nugget diameter.

4. The resistance spot welding method according to claim 1, wherein the current in the low current energization is ⅓ times or more and ⅔ times or less the current in the high current energization.

5. The resistance spot welding method according to claim 1, wherein the main energization step includes a constant current energization that performs energization at a constant current that is lower than or equal to the current in the high current energization and is higher than or equal to the current in the low current energization.

6. The resistance spot welding method according to claim 2, wherein the main energization step includes performing the slope energization while increasing the current up to a predetermined first current and then performing the constant current energization at a current higher than or equal to the first current.

7. The resistance spot welding method according to claim 2, wherein the main energization step includes performing the energization until a nugget diameter, which is a diameter of the nugget, reaches a pre-determined target nugget diameter, and
the target diameter is 1.2 times or more the target nugget diameter.

8. The resistance spot welding method according to claim 2, wherein the current in the low current energization is ⅓ times or more and ⅔ times or less the current in the high current energization.

9. The resistance spot welding method according to claim 2, wherein the main energization step includes a constant current energization that performs energization at a constant current that is lower than or equal to the current in the high current energization and is higher than or equal to the current in the low current energization.
